(19) United States
(12) Patent Application Publication
(10) Pub. No.: US 2011/0029384 A1
(43) Pub. Date: Feb. 3, 2011

(54) SYSTEM AND METHOD FOR DYNAMIC TARGETING ADVERTISEMENT BASED ON CONTENT-IN-VIEW

(75) Inventors: Jianbin Wei, Redwood City, CA (US); Jun Feng, Mountain View, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/512,715

(22) Filed: Jul. 30, 2009

(51) Int. Cl. G06Q 30/00; G06F 17/30; G06F 17/21; G06F 3/048

(52) U.S. Cl. 705/14.53; 707/E17.108; 715/269; 715/784; 715/800

(57) ABSTRACT

A system and method for dynamically targeting advertisements based on content-in-view of a web page. The system includes an extraction module for extracting a plurality of keywords from at least one content area associated with a web page. The web page is presented to a user in response to a search request. An approximation module generates an approximated view of the portion of the web page currently being viewed by the user. In turn, one or more advertisements are selected to be displayed to the user based on content associated with the approximated view.

### SUMMARY

The present application provides a system and method for dynamically targeting advertisements based on content-in-view of a web page. As used herein, the term content-in-view refers to the content of a web page that is currently visible to a user. The system includes a web crawler for actively retrieving a plurality of web pages from a network. The web crawler stores the plurality of web pages into a repository communicatively linked to an extraction engine. The extraction engine is configured to extract a plurality of keywords from one or more content areas associated with each web page in the repository.

The system further includes an indexer in communication with the extraction engine. The indexer is configured to index each web page in a search index based on the plurality of keywords extracted by the extraction engine. A search engine in communication with the search index is operable to retrieve a web page therefrom and display the web page to a user in response to a search request. An approximation engine communicatively linked to the search engine is configured to generate an approximated view of the portion of the web page currently being viewed by the user. Based on the approximated view and at least one keyword associated therewith, an advertisement is presented on the web page for display to the user.

Further objects, features and advantages of this application will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for targeting advertisements based on content-in-view of a web page;

FIG. 2A is a web page to be displayed to the user;

FIGS. 2B and 2C depict a client device displaying certain portions of the web page of 2A;

FIG. 3 is a flowchart illustrating a method for targeting advertisements based on content-in-view of a web page; and

FIG. 4 is a schematic view of a computer system for implementing the methods described.

### DETAILED DESCRIPTION

With the advent of the Internet, Internet-based advertising has become increasingly popular among advertisers for promoting their products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc.

Client devices, communicatively coupled to a network such as the Internet, are capable of accessing various websites that may display advertisements. For example, a user of a client device may submit a search request comprising one or more terms to a search engine, which causes the search engine to retrieve a result set comprising links to content, as well as advertisements related to the search terms provided by a user. The search engine generates and displays a result set to a user who may then select or view items in the result set, including one or more advertisements. Revenue for the search engine provider is typically generated from the advertisements that are displayed to users in response to search requests.

Internet publishers supported by advertising may include e-mail providers, content providers, search engine providers, etc. Such Internet publishers typically charge advertisers for displaying advertisements based on various pricing models. For instance, an advertiser may agree to pay each time the advertisement is displayed, as in cost per impression (CPM) pricing. Alternatively, an advertiser may agree to pay each time the advertisement is clicked or selected by a user, as in cost per click (CPC) pricing, or similarly, each time a specified action associated with the advertisement occurs, as in cost per action (CPA) pricing. As used herein, it should be understood that the term “action” can be any desired result specified by an advertiser, including, but not limited to, a click, purchase, download, registration, etc.

Notwithstanding the type of pricing model in place, advertisements are typically displayed according to a variety of factors. For instance, advertisements directed to younger Internet users may be placed on websites related to young celebrities, pop culture, or modern music. In order to increase expected revenue, an advertisement may be placed near the top of a webpage to attract greater attention thereto. Yet this often requires increased costs with no assurances that the advertisement will attract any significant click-through traffic. As a result, an advertiser might be dissuaded altogether from placing the advertisement on a particular website or webpage. Advertisements may also be selected based on an overall theme associated with a web page. The overall theme of a particular web page may be ascertained by analyzing the content presented therein. Accordingly, an advertisement may be selected by matching keywords/and or phrases within the advertisement and the web page. Yet such techniques may lead to erroneous results. By way of example, a web page directed to former U.S. President “George Washington” may trigger advertisements directed to hotels in the state of Washington. In these instances, the actual content of the web page may quite different than, or of relatively little relevance to the content currently being viewed by the user.

Moreover, even in instances where the selected advertisements are consistent with the theme of the article, it would also be beneficial if there existed a technique for displaying advertisements geared to the particular section of the article currently being viewed by the user. By way of example, consider an article regarding the ten best cities to live in the United States. Using conventional online advertising methods, the advertisements displayed in conjunction with such an article would likely be based on keywords and/or phrases related to the overall theme, e.g., “cost of living,” “education,” “job growth,” “home financing,” etc. In contrast, by using keywords associated with each section of the article (in this case, e.g., such keywords may include names of local attractions and businesses associated with the city discussed in a particular section), advertisements more directly related to the corresponding section can be displayed when being viewed by the user. Accordingly, tailoring advertisements more directly towards the particular interests of the user rather than the overall theme of the web page, can increase the expected probability of action (e.g., clicks, downloads, purchases, etc.) associated with a given advertisement, thereby yielding increased revenues.

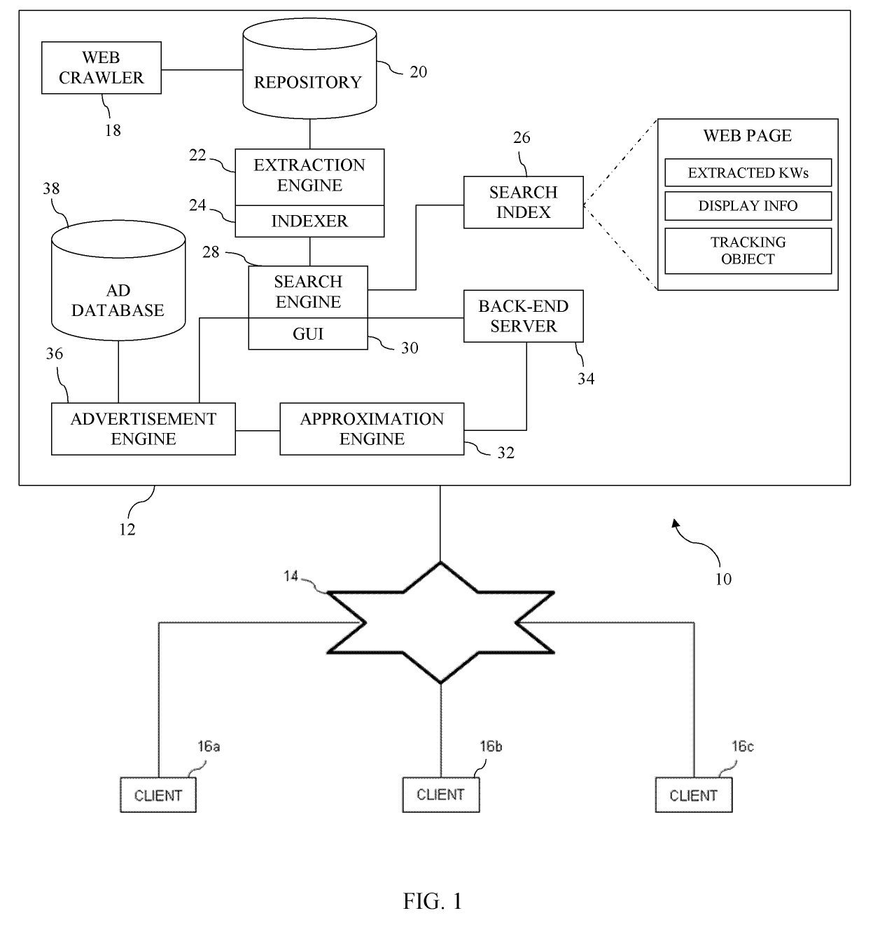

Referring now to FIG. 1, a system embodying the principles of the present application is illustrated therein and designated at 10. The system 10 comprises a server 12 capable of being in communication with a distributed network 14, which may include a connection to one or more local and/or wide area networks, such as the Internet. The server 12 may be a computing device, for example, operable to responsively execute requests from one or more users via client devices 16a, 16b, and 16c coupled to the network 14. While only one server 12 is depicted in the drawings, it should be understood to those of ordinary skill in the art that the system 10 may incorporate a plurality of servers.

The server 12 includes at least one web crawler 18 (also known as a bot or spider) for retrieving a plurality of web pages from the network 14. The web crawler 18 is also configured to retrieve metadata and cascading style sheets (CSS) information associated with the plurality of web pages. CSS includes rules governing how a document such as a web page is presented on a web browser running on a client device (e.g., 16a, 16b, or 16c). For instance, CSS covers fonts, colors, margins, lines, height, width, alignment and positioning, background images, etc.

The web crawler 18 may be programmed to actively retrieve the plurality of web pages by crawling any type of accessible sources available on the network 14. Although the web crawler 18 is described for the purpose of retrieving web pages, it is to be understood that the web crawler 18 is not so limited and may be configured to retrieve a broad range of data, including any readable and/or storable content.

The web crawler 18 is configured to store the plurality of web pages, including any associated metadata and CSS information, into a repository 20 in communication therewith. The repository 20 may be implemented as any type of data storage structure capable of providing for the retrieval and storage of a variety of data types. For instance, the repository 20 may comprise one or more accessible memory structures such as a database, CD-ROM, tape, digital storage library, flash drive, floppy disk, optical disk, magnetic-optical disk, erasable programmable read-only memory (EPROM), random access memory (RAM), magnetic or optical cards, etc.

The server 12 further includes an extraction engine 22 communicatively linked to the repository 20. The extraction engine 22 is a hardware and/or software module configured to extract a plurality of keywords from each web page in the repository 20. More specifically, the extraction engine 22 scans a web page and extracts keywords contextually related to content presented in each content area (i.e., any region of the web page containing content) of the web page. Content may include published information, such as articles, and/or other data of interest to users, often displayed in a variety of formats, such as text, video, audio, hyperlinks, or other known formats. As used herein, it is to be understood that the term “keyword” may refer to a single word (e.g., “boat”), or a string of words (e.g., “Chicago Bulls” or “The Phantom of the Opera”).

The extraction engine 22 may employ various techniques for extracting the keywords, such as, but not limited to, machine learning models, semantic and/or statistical based algorithms, etc. According to one embodiment, for example, the keywords may be extracted according to weighted values assigned to each keyword. For each content area, for example, the extraction engine 22 may assign a value to a certain keyword based on numerous parameters such as, but not limited to, the frequency the keyword appears within the content area, the location of the keyword, the formatting style (e.g., font, alignment, color, size, etc.) of the keyword, etc.

By way of example, a keyword appearing numerous times within a web page may be assigned a higher weight than a keyword appearing only once within the web page. Similarly, a keyword appearing at the top of a web page (e.g., the title of an article), or a keyword appearing in an alternative font (e.g., larger size, bold, italic, underlined, etc.) may be assigned a higher weight than another keyword appearing within the web page. For a given web page including n content areas (where 1≦n≦∞), each content area may be represented as a vector V of weighted keywords (KW₁ . . . KWₙ)

V₁=<KW₁, Value₁ . . . KWₙ, Valueₙ>.

Thus, the extraction engine 22 analyzes each content area of a web page and extracts a plurality of keywords therefrom based on their corresponding values.

The system 10 further includes an indexer 24 communicatively linked to the extraction engine 22. The indexer 24 is a hardware and/or software module configured to index the plurality of web pages into one or more search indexes 26 associated with a search engine 28. For instance, the indexer 24 may initially separate and analyze various components of the plurality of web pages, such as titles, headings, outbound links, inbound links, insite links, text, constructs, formatting styles, etc. The plurality of web pages may be subsequently indexed in the search index 26 according to one or more of the foregoing components. According to the preferred embodiment, the indexer 24 indexes the plurality of web pages into the search index 26 at least according to the plurality of keywords extracted from each web page. Thus, each web page stored in the search index 26 includes a pre-extracted set of keywords corresponding to the content area(s) associated with that web page.

The search engine 28 is communicatively linked to the network 14 and is operable to receive and process search requests comprising one or more keywords. For instance, a user may query the search engine 28 via a front-end server such as a graphical user interface 30 communicatively linked to the search engine 28 and the user's client device (e.g., 16a, 16b, or 16c). Upon receiving a search request, the search engine 28 searches the search index 26 and returns one or more web pages to the user.

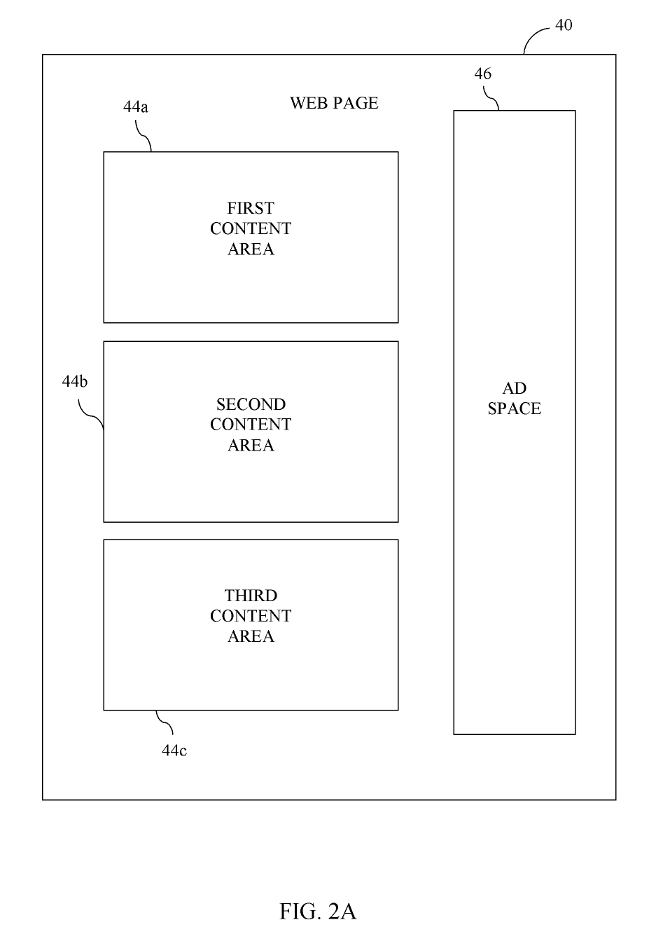

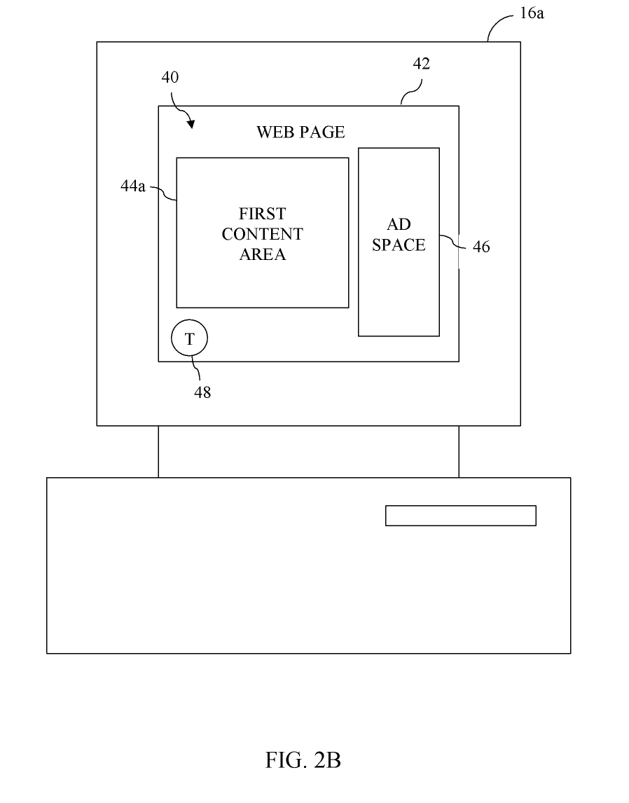

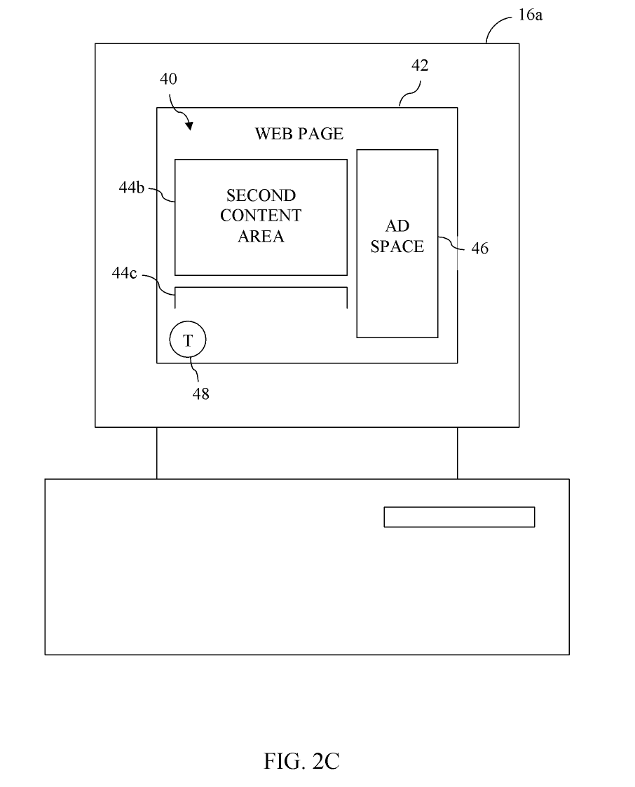

The server 12 further includes an approximation engine 36 communicatively linked to the search engine 28. The approximation engine 32 is a hardware and/or software module configured to generate an approximated view of the portion of a web page currently being displayed to a user. Although metadata and/or CSS information associated with the web page indicates how the web page is to be displayed on the user's browser window, various attributes and events (e.g., scrolling, modifying window and/or font size, etc.) may alter the presentation of the web page. Therefore, the web page displayed to the user may include a tracking object 48 (shown in FIGS. 2B and 2C) embedded in the web page to track user interactions in a browser window of the user's client device.

For instance, the tracking object 48 may include a component such as an applet program written in an interpretive language such as Java™. Alternatively, the tracking object 48 may include a program written in scripting language such as JavaScript™ to track and gather user activity. Moreover, a Java applet and a JavaScript code embedded in a web page may collectively be used to gather data for estimating which portion of the web page a user is currently viewing. Furthermore, the tracking object 48 may be configured to obtain operating system and screen resolution data of the client device (e.g., 16a, 16b, or 16c) used by a user. In this manner, movements on the screen can be related to page size and the like so that the approximation engine 32 may generate more accurate approximations.

According to one embodiment, the system 10 includes a back-end server 34 for receiving data indicative of user activity from the tracking object. The back-end server 34 may be integrated with the approximation engine 32 as a single unit, or may be communicatively linked to the approximation engine 32 and a front-end server such as the graphical user interface 30, as shown in FIG. 1. Moreover, while the back-end server 34 is shown in the figures as being incorporated with the server 12, it is to be understood that the back-end server 32 may be provided as a separate component remotely connected to the server 12.

The back-end server 34 is operable to receive data indicative of user interactions from the tracking object 48 and transmit the data to the approximation engine 32. In turn, the approximation engine 32 generates an approximated view of the portion of a web page currently being viewed by a user. As previously mentioned, metadata and/or CSS information associated with the web page provide an initial indication as to how the web page is presented to the user. Thus, if the data received from the back-end server 32 indicates that no pertinent browsing events have taken place (e.g., scrolling, zooming, modifying window and/or font size etc.), then the approximation engine 32 generates an approximated view based on the metadata and/or CSS information previously retrieved and processed. Alternatively, if the data indicates that a pertinent browsing event has occurred, the approximation engine 32 adjusts the approximated view accordingly. Thus, the approximated view is essentially a function of two primary inputs: (1) the metadata and/or CSS information associated with the web page 40; and (2) the data indicative of the user interactions.

The server 12 further includes an advertisement engine 36 in communication with the search engine 28 and the approximation engine 32. The advertisement engine 36 is a hardware and/or software module configured to search an advertisement database 38 and retrieve one or more advertisements related to a web page displayed to a user. While the advertisement engine 36 is shown in FIG. 1 as being incorporated with the server 12, it is to be understood that the advertisement engine 36 may be provided as a separate component, and/or may be controlled by a separate entity (e.g., an advertising agency).

Analogous to the repository 20, the advertisement engine 38 and the search index 26 may each comprise one or more accessible memory structures such as a database, CD-ROM, tape, digital storage library, flash drive, floppy disk, optical disk, magnetic-optical disk, erasable programmable read-only memory (EPROM), random access memory (RAM), magnetic or optical cards, etc.

Referring now to FIGS. 2A-2C, the operation of the system 10 will not be discussed. In FIG. 2A, a web page 40 retrieved by the search engine 28 to be displayed to a user on a browser 42 of a client device 16a is shown. The web page 40 includes three content areas 44a, 44b, 44c and advertising space 46 for the placement of advertisements. As will be appreciated by those of ordinary skill in the art, the layout of a particular web page may take numerous forms. Accordingly, it is to be understood that the layout of the web page 40 depicted in the figures is merely intended for purposes of illustration and should not be construed as limiting.

As is common with many web pages, the size of the web page 40 depicted in FIG. 2A is too large to fit within the browser 42. Hence, the browser 42 does not show the entire web page 40 but rather defines a currently visible area which is just a fraction of the web page 40, such that at any given time only part of the web page 40 is within the currently visible area. In FIG. 2B, for instance, it can be seen that the portion of the web page 40 currently being viewed by the user only includes the first content area 44a and a portion of the advertising space 46.

After the search engine 28 returns the requested web page 40 to the user, the approximation engine 32 is configured to generate an approximated view of the portion of the web page 40 currently being viewed by the user (i.e., the portion of the web page currently displayed on the browser 42). In the present example, it is assumed that the approximated view is generated immediately when the web page 40 is rendered on the browser 42, and therefore prior to any user activity that may alter the manner in which the web page 40 is presented.

Based on the approximated view, the advertisement engine 36 may apply a matching algorithm to retrieve one or more advertisements to be displayed in the visible portion of the advertising space 46. More particularly, the advertisement engine 36 analyzes the plurality of keywords from the web page 40 that have been previously extracted by the extraction engine 22 and stored in the search index 26, and retrieves one or more advertisements contextually related thereto. In FIG. 2B, for instance, the advertisement engine 36 is configured to retrieve an advertisement from the advertisement database 38 based on the plurality of keywords associated with the first content area 44a. Of course, it should be understood that the advertisement engine 36 may also taken into account size and coordinates of the location the advertisement is to be displayed. Moreover, the advertisement engine 36 may also select an advertisement based on a corresponding expected revenue (e.g., expected revenue for a given advertisement may be calculated according to a historical click-through rate associated with the advertisement). The advertisement is subsequently displayed in the portion of the advertising space 46 adjacent to the first content area 44a.

In the event of a user interaction, the approximation engine 32 may be configured to dynamically generate a new approximated view of the web page. As previously discussed, a tracking object 48 is embedded in the web page and is configured to track various events, particularly those which may alter the appearance of the web page 40. For instance, the tracking object 48 may be operable to detect user activities such as, but not limited to, scrolling, zooming, resizing a window and or font, modifying font, etc. The back-end server 34 is configured to actively receive feedback information indicative of such user interactions from the tracking object 48 and relay them to the approximation engine 32.

The approximation engine 32 responsively regenerates an approximated view of the portion of the web page 40 currently visible in the browser 42. The advertisement engine 36 then analyzes the approximated view and if necessary, retrieves a new advertisement to be displayed in the advertising space based on the approximated view. In FIG. 2C, for instance, it can be seen that the user has scrolled down the web page 40 such that the second content area 44b and a portion of the third content area 44c are currently displayed to the user. Since it can be seen that the second content area 44b comprises the majority of the visible content visible, the advertisement engine 36 is configured to retrieve one or more advertisements from the advertisement database 38 based on the plurality of keywords corresponding to the second area 44b. Nonetheless, the advertisement engine 36 may further be configured to retrieve one or more advertisements relating to the plurality of keywords associated with the third content area 44c (e.g., if space permits, if the advertisement engine 36 determines more than a predetermined amount of content is visible, etc.).

Furthermore, there may be instances where the user event which prompted the regeneration of the approximated view is of little or no significance to the manner in which the web page 40 is currently being displayed to the user. For instance, the user may press a “right” or “left” arrow key of a keyboard associated with the client device 16a (e.g., perhaps inadvertently or to center the content of the web page 40), yet the content visible to the user may remain entirely or substantially unchanged. In such cases, it would not be necessary for the advertisement engine 36 to retrieve a new advertisement. Nonetheless, the advertisement engine 32 may be configured to automatically replace an existing advertisement with a new advertisement, e.g., after a predetermined period of time has elapsed, in response to predetermined action such as a click-through, etc.

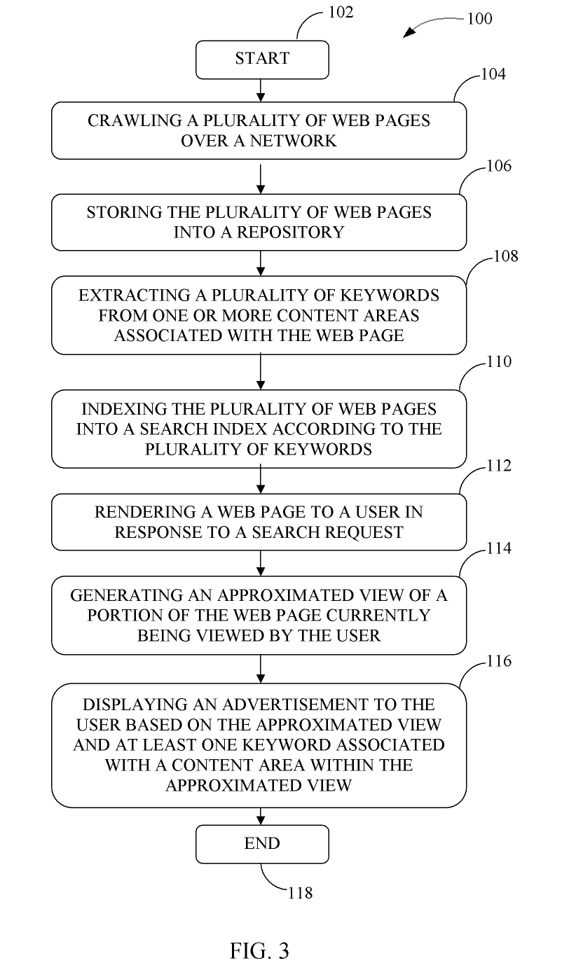

Referring now FIG. 3, a method 100 for dynamically targeting advertisements based on content-in-view of a web page starts in block 102. At block 104, a plurality of web pages are actively crawled over a network. The plurality of web pages and any display information associated therewith are stored into a repository at block 106. At block 108, a plurality of keywords are extracted from each web page in the repository. In particular, the plurality of keywords are extracted from one or more content areas associated with a web page. The plurality of web pages are subsequently indexed into a search index at block 110. In response to a search request, a web page selected from the search index is rendered to a user at block 112.

Continuing with block 114, an approximated view of a portion of the web page currently being viewed by the user is generated. The approximated view may be based on the display information associated with the web page, as well as one or more user events. At block 116, one or more advertisements are displayed to the user. The one or more advertisements are selected according to at least one keyword associated the approximated view. In particular, the at least one keyword is located in at least one content area within the approximated view. The method ends at block 118.

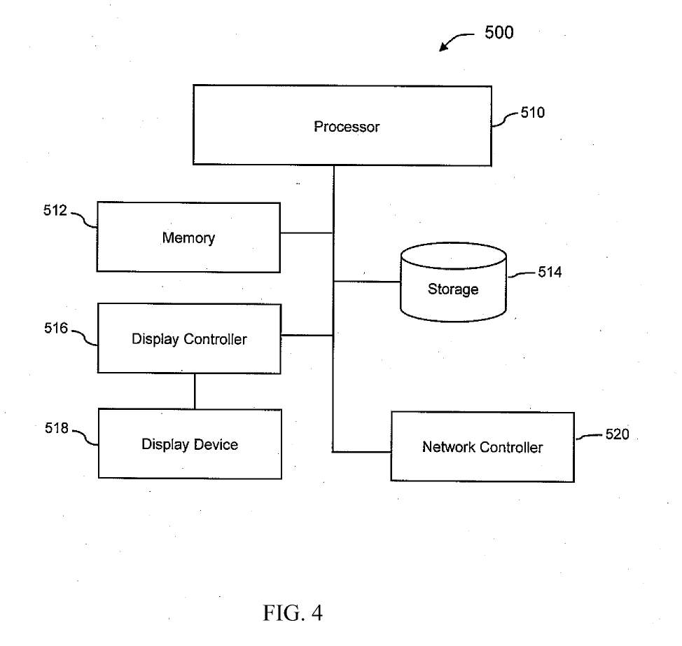

Any of the modules, servers, or engines described may be implemented in one or more computer systems. One exemplary system is provided in FIG. 4. The computer system 500 includes a processor 510 for executing instructions such as those described in the methods discussed above. The instructions may be stored in a computer readable medium such as memory 512 or storage devices 514, for example a disk drive, CD, or DVD. The computer may include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the Internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this application. This description is not intended to limit the scope or application of this application in that the system 10 is susceptible to modification, variation and change, without departing from spirit of this application, as defined in the following claims.

We claim:

1. A system for dynamically targeting advertisements based on content-in-view of a web page, the system comprising:
a web crawler for actively retrieving a plurality of web pages from a network, the plurality of web pages including associated display information;
a repository for storing the plurality of web pages;
an extraction engine in communication with the repository and operable to extract a plurality of keywords from each web page of the plurality of web pages;
an indexer in communication with the extraction engine and operable to index each web page in a search index based on the plurality of keywords;
a search engine in communication with the search index and operable to retrieve and display a web page to a user in response to a search request, the web page being selected from the plurality of web pages;
an approximation engine in communication with the search engine and operable to generate an approximated view of a portion of the web page currently being viewed by the user, the approximated view being based on display information associated with the web page; and
an advertisement engine in communication with the approximation engine and operable to retrieve at least one advertisement to be displayed to the user, the at least one advertisement being selected according to the approximated view and at least one keyword of the plurality of keywords associated with the approximated view.

2. The system of claim 1, wherein the extraction engine extracts the plurality of keywords from a set of content areas associated with the plurality of web pages.

3. The system of claim 2, wherein the approximated view includes at least one content area of the set of content areas.

4. The system of claim 3, wherein the at least one keyword is associated with the at least one content area.

5. The system of claim 1, wherein the approximated view is further based on at least one user event.

6. The system of claim 5, further comprising a back-end server in communication with the search engine and operable to receive information indicative of the at least one user event therefrom, the back-end server being communicatively linked to the approximation engine and operable to transmit the indicative information thereto.

7. The system of claim 6, wherein the at least one user event includes at least one event selected from the group consisting of: scrolling the web page, modifying font associated with the web page, zooming in/out the web page, and resizing a window displaying the web page.

8. The system of claim 1, wherein the at least one advertisement is further selected according to a corresponding expected revenue.

9. The system of claim 1, wherein the advertisement engine is configured to retrieve an additional advertisement to be displayed to the user after a predetermined period of time.

10. A method for dynamically targeting advertisements based on content-in-view of a web page, the method comprising:
crawling a plurality of web pages over a network and storing the plurality of web pages in a repository, the plurality of web pages including associated display information;
extracting a plurality of keywords from each web page of the plurality of web pages in the repository;
indexing the plurality of web pages into a search index based on the plurality of keywords;
rendering a web page to a user in response to a search request, the web page being selected from the plurality of web pages;
generating an approximated view of a portion of the web page currently being displayed to a user, the approximated view being based on display information associated with the web page; and
displaying at least one advertisement to the user based on the approximated view and at least one keyword of the plurality of keywords associated with the approximated view.

11. The method of claim 10, wherein the plurality of keywords are extracted from a set of content areas associated with the plurality of web pages.

12. The method of claim 11, wherein the approximated view includes at least one content area of the set of content areas, the at least one keyword being associated with the at least one content area.

13. The method of claim 10, wherein the approximated view is further based on at least one user event.

14. The method of claim 13, wherein the at least one user event includes at least one user event selected from the group consisting of: scrolling the web page, modifying font associated with the web page, zooming in/out the web page, and resizing a window displaying the web page.

15. The method of claim 10, further comprising applying a matching algorithm to select the at least one advertisement.

16. In a computer readable storage medium having stored therein instructions executable by a programmed processor for dynamically targeting advertisements based on content-in-view of a web page, the storage medium comprising instructions for:
crawling a plurality of web pages over a network and storing the plurality of web pages in a repository, the plurality of web pages including associated display information;
extracting a plurality of keywords from each web page of the plurality of web pages in the repository;
indexing the plurality of web pages into a search index based on the plurality of keywords;
rendering a web page to a user in response to a search request, the web page being selected from the plurality of web pages;
generating an approximated view of a portion of the web page currently being displayed to a user, the approximated view being based on display information associated with the web page; and
displaying at least one advertisement to the user based on the approximated view and at least one keyword of the plurality of keywords associated with the approximated view.

17. The computer readable storage medium of claim 16, wherein the plurality of keywords are extracted from a set of content areas associated with the plurality of web pages.

18. The computer readable storage medium of claim 17, wherein the approximated view includes at least one content area of the set of content areas, the at least one keyword being associated with the at least one content area.

19. The computer readable storage medium of claim 16, wherein the approximated view is further based on at least one user event, the at least one user event including at least one user event selected from the group consisting of: scrolling the web page, modifying font associated with the web page, zooming in/out the web page, and resizing a window displaying the web page.

20. The computer readable storage medium of claim 16, further comprising applying a matching algorithm to select the at least one advertisement.
